(19) United States
(12) Patent Application Publication
(10) Pub. No.: US 2014/0055940 A1
(43) Pub. Date: Feb. 27, 2014

(54) MEMORY DEVICE

(71) Applicants: Chien Cheng Chen, Hsinchu City (TW); Chun-Lung Chuang, Hsinchu City (TW); MING CHUNG CHEN, Hsinchu City (TW); YUN-TING WANG, Hsinchu City (TW); Yen-Chi Peng, Hsinchu City (TW); CHENG HUNG WANG, Hsinchu City (TW)

(72) Inventors: Chien Cheng Chen, Hsinchu City (TW); Chun-Lung Chuang, Hsinchu City (TW); MING CHUNG CHEN, Hsinchu City (TW); YUN-TING WANG, Hsinchu City (TW); Yen-Chi Peng, Hsinchu City (TW); CHENG HUNG WANG, Hsinchu City (TW)

(73) Assignee: SKYMEDI CORPORATION, Hsinchu City (TW)

(21) Appl. No.: 13/591,001

(22) Filed: Aug. 21, 2012

(51) Int. Cl. G06F 1/16

(52) U.S. Cl. 361/679.32; 361/679.31

(57) ABSTRACT

A memory device includes a control board and a conductive housing. In one embodiment, a circuit ground in the control board is electrically coupled to the conductive housing to make a common ground contact. In another embodiment, differential impedances at different locations of a conductor are controllably maintained within a specified range by adjusting width of the conductor and/or spacing between the adjacent conductors of a differential pair.

### BACKGROUND OF THE INVENTION

1. Field of the Invention

The present invention generally relates to a memory device, and more particularly to a memory device with reduced noise and/or differential impedance within a specified range.

2. Description of Related Art

USB 3.0 is the third revision of Universal Serial Bus (USB) standard that defines connectors and protocols for connection between computers and electronic devices. USB 3.0 supports 5 Gbps data rate (i.e., Super Speed) that is greatly higher than 480 Mbps (i.e., High Speed) supported by USB 2.0, the second revision of USB standard. The data rate supported by USB 3.0 may probably be liable to noise (e.g., power noise), which may affect signal integrity to cut down the data rate. The data rate supported by USB 3.0 may also be affected with impedance, particularly differential impedance for differential pairs, which increases reflection due to impedance mismatch or impedance not within a range as specified USB 3.0 specification.

Chip-on-board (COB) is a packaging technique that directly mounts a bare silicon chip, for example, on a printed circuit board, followed, by being coated with molding material to protect the bare silicon chip. Owing to its advantages of higher signal densities and smaller overall packages, the COB technique has recently been adopted in electronic devices (e.g., flash memory devices) with a USB connector to make the electronic devices more versatile, having higher density and more miniaturized. However, the bare silicon chip confined, in the molding material may have difficulty dissipating heat or being replaced in case the silicon chip is damaged.

For the foregoing reasons, a need has thus arisen to propose a novel memory device capable of shielding itself against power noise and maintaining differential impedance within the range as specified in USB 3.0 specification.

### SUMMARY OF THE INVENTION

In view of the foregoing, an embodiment of the present invention provides a memory device that makes a common ground contact for both a circuit and a conductive housing, thereby shielding the circuit against power noise. An embodiment of the present invention provides a memory device with differential impedances at different locations being controllably maintained within, a specified range.

According to one embodiment, a memory device includes a control board and a conductive housing. The control board includes a substrate, a plurality of first conductors disposed on a front portion of the substrate, a plurality of second conductors disposed above the substrate and back from the first conductors, and an insulation holder having a plurality of through-holes through which the second conductors pass. The conductive housing encloses the control board. In one embodiment, a circuit ground in the control board is electrically coupled to the conductive housing to make a common ground contact. In another embodiment, differential impedances at different locations of the second conductor are controllably maintained within a specified range by adjusting width of the second conductor and/or spacing between the adjacent second conductors of a differential pair.

### BRIEF DESCRIPTION OF THE DRAWINGS

FIG. 1 shows an exploded, perspective view of a memory device with reduced noise according to an embodiment of the present invention;

FIG. 2A shows a perspective view of the support frame with the control board of FIG. 1;

FIG. 2B shows a perspective view of the control board with the insulation holder;

FIG. 3 shows an enlarged perspective view of the second conductors of FIG. 1;

FIG. 4 shows another perspective view of the support frame with the control board of FIG. 1;

FIG. 5 shows a side cross-sectional view of the control board of FIG. 1.;

FIG. 6A shows an exemplary cross-sectional view of the control board along A-A′ of FIG. 5;

FIG. 6B shows an exemplary cross-sectional view of the control board along B-B′ of FIG. 5;

FIG. 6C shows an exemplary cross-sectional view of the control board along C-C′ of FIG. 5;

FIG. 7A shows return, loss for transmitter differential pair (TX) before and after width/spacing adjustment;

FIG. 7B shows return loss for receiver differential pair (RX) before and after width/spacing adjustment;

FIG. 8A shows voltage standing wave ratio (VSWR) for transmitter differential pair (TX) before and after width/spacing adjustment; and

FIG. 8B shows VSWR for receiver differential pair (RX) before and after width/spacing adjustment.

### DETAILED DESCRIPTION OF THE INVENTION

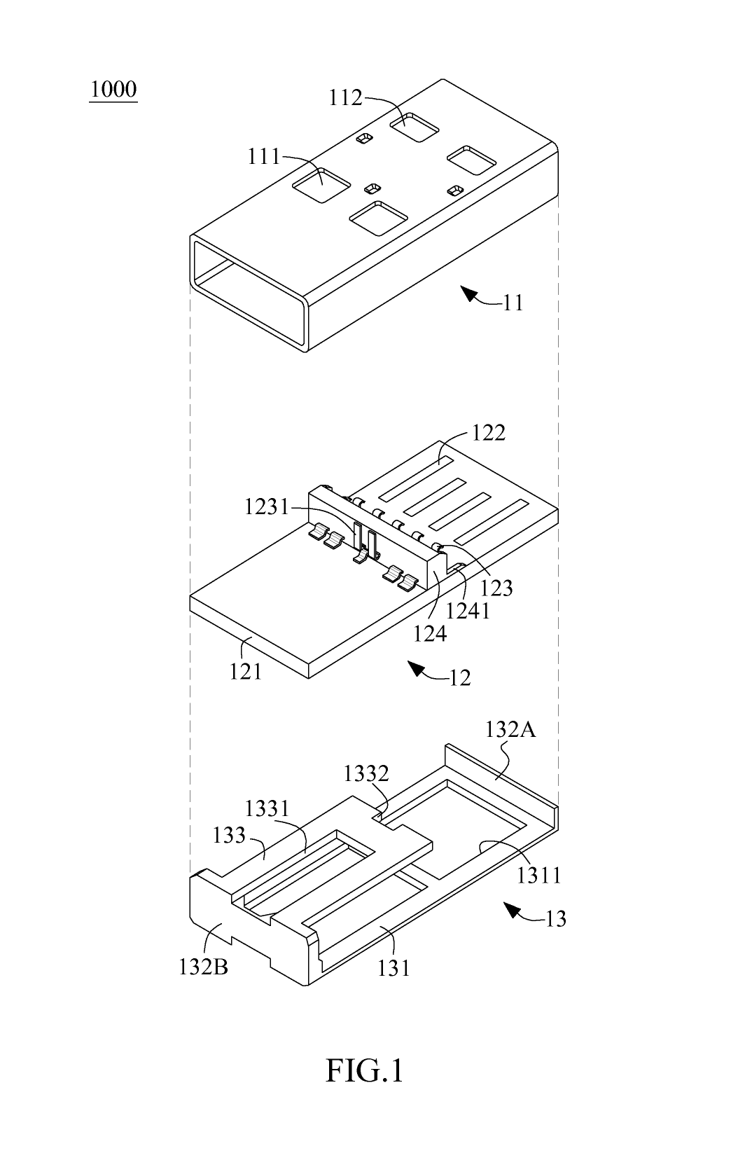

FIG. 1 shows an exploded perspective view of a memory device 1000 with reduced noise according to an embodiment of the present invention. The embodiment is exemplified by, but not limited to, a flash memory device with a plug connector that conforins to USB 3.0 specification.

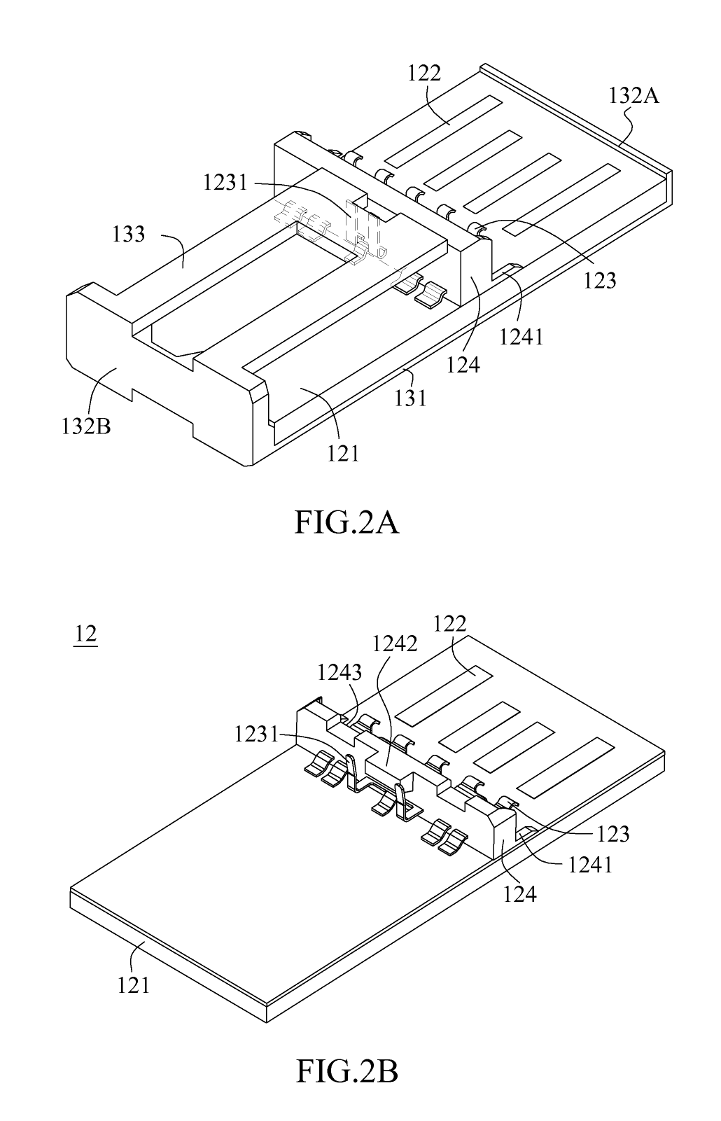

As shown in FIG. 1, the memory device 1000 includes a conductive housing 11, a control board 12 and a support frame 13. The support frame 13 is used to support the control board 12 as shown in FIG. 2A. The support frame 13 with the control board 12 may then be enclosed by the conductive housing 11.

Specifically speaking, the support frame 13 includes a base plate 131 that is used to carry the control board 12. Two sidewalls, that is, a front sidewall 132A and a rear sidewall 132B substantially vertically extend from a front side and a rear side of the base plate 131, respectively. Accordingly, the base plate 131, the front sidewall 132A and the rear sidewall 132B define a space, into which the control board 12 may be fitted. In the specification, “front” is referred to a part that faces a receptacle connector (not shown) that the memory device 1000 may be plugged into. Although the front sidewall 132A and the rear sidewall 132B as demonstrated in the embodiment are used to confine the control board 12, the front and rear sidewalls 132A and 132B may, however, be omitted in an embodiment, in which the control board 12 may be held by the support frame 13 via, other fixing schemes. In the embodiment, a top plate 133 may optionally extend from a top side (being opposite to a bottom side at which the base plate 131 and the rear sidewall 132B meet) of the rear sidewall 132B, and be substantially parallel to the base plate 131. The base plate 131 of the embodiment may have at least one opening 1311 to facilitate heat dissipation. The top plate 133 may also have at least one opening 1331 to facilitate heat dissipation. Moreover, the opening 1331 of the top plate 133 may be used to well accommodate an electronic component or components (not shown) that are disposed on a top surface of the conductive board 12.

As shown in FIG, 1, the conductive housing 11 of the embodiment may have at least one heat dissipation hole or opening 111 configured, for example, on a top surface of the conductive housing 11. The conductive housing 11 may have at least one securing hole 112 configured, for example, on a top surface of the conductive housing 11 such that the memory device 1000 may be firmly attached to a receptacle connector (not shown) after the memory device 1000 is plugged into the receptacle connector.

In the embodiment, as shown in FIG. 1, the control board 12 primarily includes a substrate 121, on a front portion of which a number of parallel first conductors 122 (e.g., golden fingers) are disposed. According to USB 3.0 specification, four first conductors 122 are respectively assigned to power (VBUS), USB 2.0 differential pair (D− and D+), and ground for power return (GND). The control board 12 also includes a number of parallel second conductors 123 that are disposed above the substrate 121 and back from the first conductors 122. According to USB 3.0 specification, five second conductors 123 are respectively assigned to Super Speed receiver differential pair (SSRX− and SSRX+), ground for signal return (GND_DRAIN) and Super Speed transmitter differential pair (SSTX− and SSTX+). The control board 12 further includes an insulation holder 124, which has a number of (e.g., five) through-holes, through which the second conductors 123 pass. The insulation holder 124 having an elongated shape traverses and is fixing unto the substrate 121 widthwise. At least two extended legs 1241 may be connected to or extended from a front side of the insulation holder 124 to resist forward tilting of the insulation holder 124. As shown in FIG. 2A, a front side of the top plate 133 of the support frame 13 may be used to resist backward tilting of the insulation holder 124. In the embodiment, the width of the insulation holder 124 should preferably be as thin as possible, for example, 0.75 to 0.9 mm, to minimize impedance discontinuity for the second conductors 123 of the receiver/transmitter differential pair. Although the insulation holder 124 as illustrated in FIG. 1 and FIG. 2A is uniform in width, the insulation holder 124 may, in general, have different width from one end to the other. FIG. 2B shows another control board 12, on which the insulation holder 124 has at least one extruded portion 1242 and at least one indented portion 1243. The insulation holder 124 with the extruded/indented portion 1242/1243 may, for example, facilitate clipping the insulation holder 124 during manufacture.

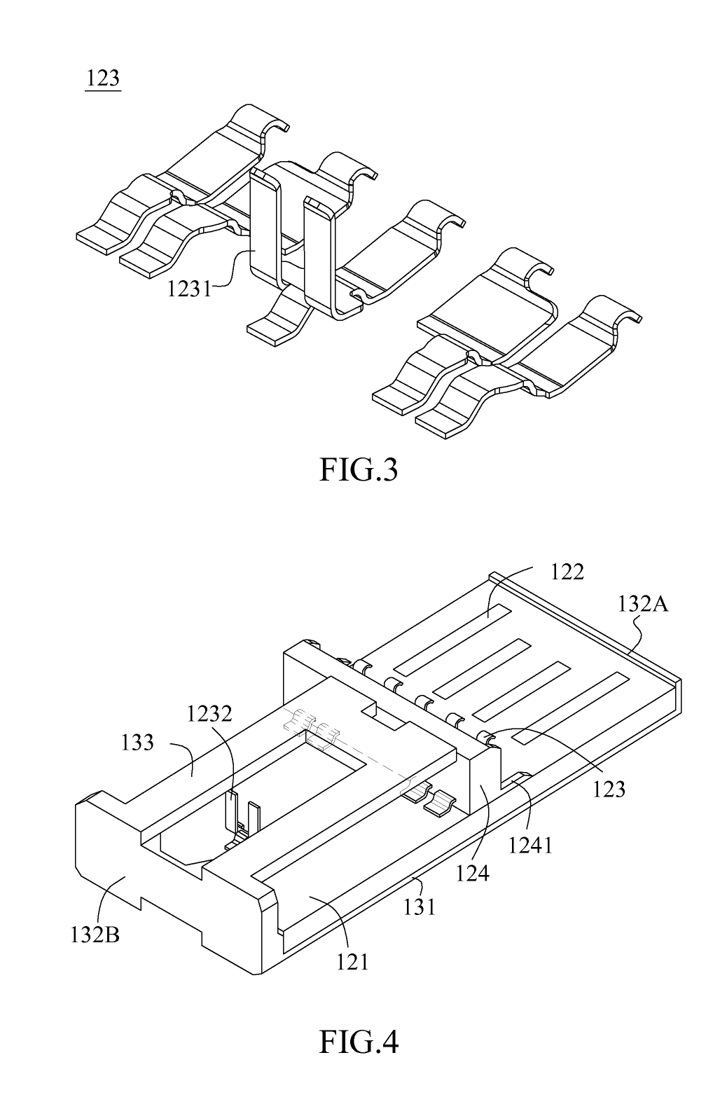

FIG. 3 shows an enlarged perspective view of the second conductors 123 of FIG. 1. Unlike the first conductor 122 that is embedded in the substrate 121 with an exposed flat surface, the second conductor 123 is disposed above the substrate 121 with a curved surface. The second conductor 123 has a front portion that is suspended from a top surface of the substrate 121, a central portion passing through the through-hole of the insulation holder 124, and a rear portion that partially rests on the top surface of the substrate 121 and electrically couples to a circuit in the control board 12, for example, via a conductive pad (not shown). According to one aspect of the embodiment, the second conductor 123 assigned to ground (for signal return) (GND_DRAIN) has at least one (first) extended conductor 1231 that may contact the conductive housing 11, thereby making a common ground contact for both a circuit in the control board 12 and the conductive housing 11. Therefore, power noise of a circuit ground in the control board 12 may be diverted from the conductive housing 11, and the circuit in the control board 12 may thus be shielded against the power noise. As exemplified in FIG. 3, two extended conductors 1231 upward extend from the second conductor 123 assigned to ground (GND_DRAIN). The extended conductors 1231 pass through an opening 1332 of the top plate 133 (FIG. 2A), and finally contact the conductive housing 11. The extended conductors 1231 need not upward extend to contact a top portion of the conductive housing 11. For example, the extended conductors 1231 may, for example, laterally extend to contact a side portion of the conductive housing 11. The common ground contact mentioned above may be made by second extended conductors 1232 other than the first extended conductors 1231 as shown in FIG. 4. The second extended conductors 1232 shown in FIG. 4 may be directly or indirectly disposed on a top surface of the substrate 121, physically contacting the conductive housing 11, and be electrically coupled to a circuit ground in the control board 12.

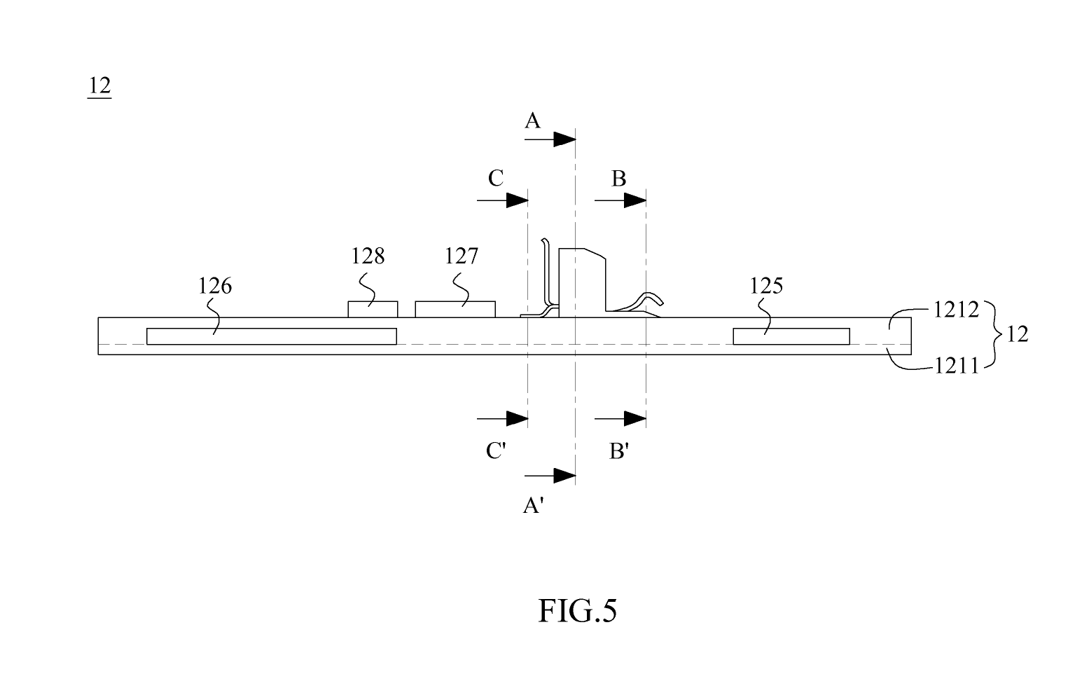

FIG. 5 shows a side cross-sectional view of the control board 12 of FIG. 1. In the embodiment, at least a memory controller 125 and a storage (e.g., flash memory) 126 are mounted on a printed circuit board (PCB) 1211 by using a chip-on-board (COB) technique. The memory controller 125 and the storage 126 are then covered with a molding layer 1212 At least one power-related circuit such as a low dropout (LDO) regulator 127 and a power converter 128 are mounted on a surface (e.g., a top surface) of the substrate 121. The heat generated by the power-related circuit 127/128 may therefore easily be dissipated via air rather than being trapped in the substrate 121.

As mentioned above, a pair of the second conductors 123 is assigned to Super Speed receiver differential pair (SSRX− and SSRX+), and another pair of the second conductors 123 is assigned to Super Speed transmitter differential pair (SSTX− and SSTX+). The receiver and transmitter differential pairs support 5 Gyps data rate (i.e., Super Speed), and differential impedance for the differential pairs should be in a range of 75-105 ohm as specified in USB 3.0 specification such that reflection due to impedance mismatch may be minimized, to assure the specified data rate.

According to another aspect of the embodiment, the differential impedances at different locations of the second conductor 123 may be controllably maintained within the specified range by adjusting width of the second conductor 123 and/or spacing between the adjacent second conductors 123. Accordingly, the widths of the second conductor 123 at different locations may in general be different, and/or spacings between the adjacent second conductors 123 at different locations may in general be different. It is noted that the widths of the second conductors 123, even of the differential pair, at the same location may in general be different. It further noted that, in the embodiment, the width and position of a contacting portion (the most front portion) of each second conductor 123 contacting the receptacle connectors (not shown) should be conformed to USB 3.0 specification.

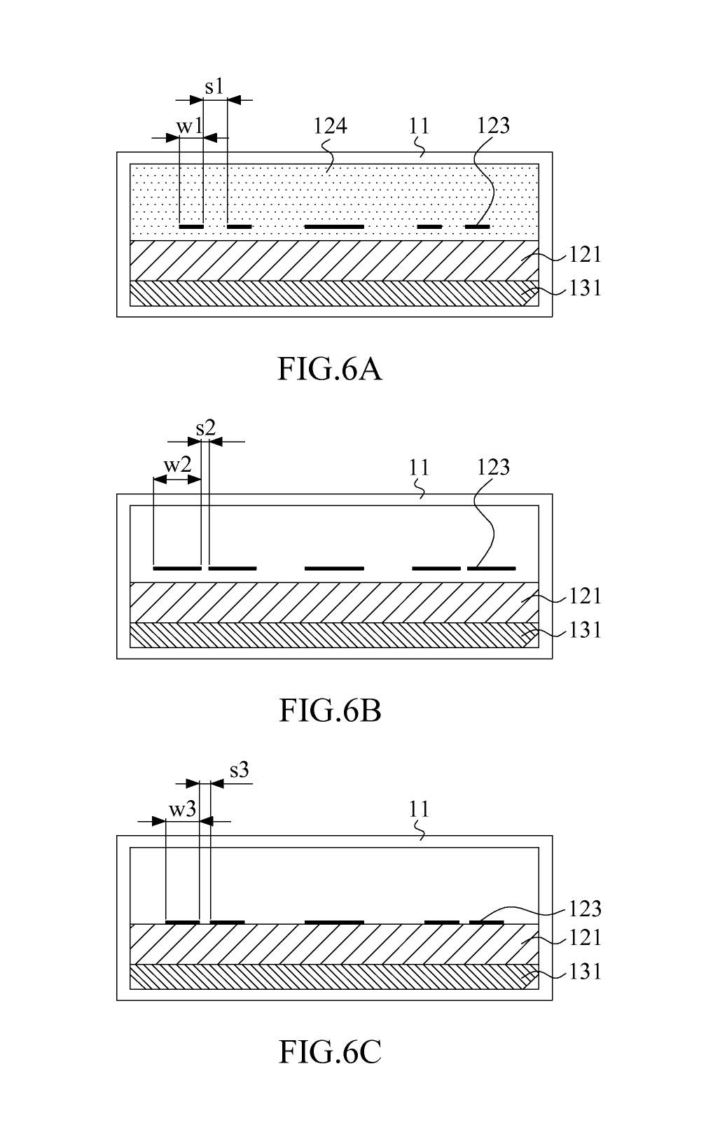

FIG. 6A shows an exemplary cross-sectional view of the control board 12 along A-A′ of FIG. 5. In this example, the differential pair of the second conductors 123 is surrounded by an insulation material of the insulation holder 124, and the differential impedance is 103 ohm, which conforms to USB 3.0 specification.

FIG. 6B shows an exemplary cross-sectional view of the control board 12 along B-B′ of FIG. 5. In this example, the differential pair of the second conductor 123 is surrounded by air, and its differential impedance (e.g., 176 ohm) tends to be higher than that in FIG. 6A provided that the differential pairs in both cases have the same width and spacing. In order to lower the differential impedance in FIG. 6B to make it within the specified range, the width w2 (e.g., 1.48 mm) of the second conductor 123 in FIG. 6B is greater than the width w1 (e.g., 0.68 mm) of the second conductor 123 in FIG. 6A, and the spacing s2 (e.g., 0.22 mm.) between the second conductors 123 of the differential pair in FIG. 6B is smaller than the spacing s1 (e.g., 0.62 mm) between the second conductors 123 of the differential pair in FIG. 6A. Accordingly, a resultant differential impedance of 100 ohm may be obtained as shown in FIG. 6B. Generally speaking, the wider the second conductor 123 is, the smaller the differential impedance is. Alternatively speaking, the smaller the spacing between the second conductors 123 of a differential pair is, the smaller the differential impedance is.

FIG. 6C shows an exemplary cross-sectional view of the control board. 12 along C-C′ of FIG. 5. In this example, the differential pair of the second conductor 123 is half surrounded by air and half surround by the substrate 121, and its differential impedance (e.g., 122 ohm) tends to be higher than that in FIG. 6A provided that the differential pairs in both cases have the same width and spacing. In order to lower the differential impedance in FIG. 6C to make it within, the specified range, the width w3 (e.g., 0.97 mm) of the second conductor 123 in FIG. 6C is greater than the width w1 (e.g., 0.68 mm) of the second conductor 123 in FIG. 6A, and the spacing s3 (e.g., 0.30 mm) between the second conductors 1.23 of the differential pair in FIG. 6C is smaller than the spacing s1 (e.g., 0.62 mm) between the second conductors 123 of the differential pair in FIG. 6A. Accordingly, a resultant differential impedance of 100 ohm may be obtained as shown in FIG. 6C.

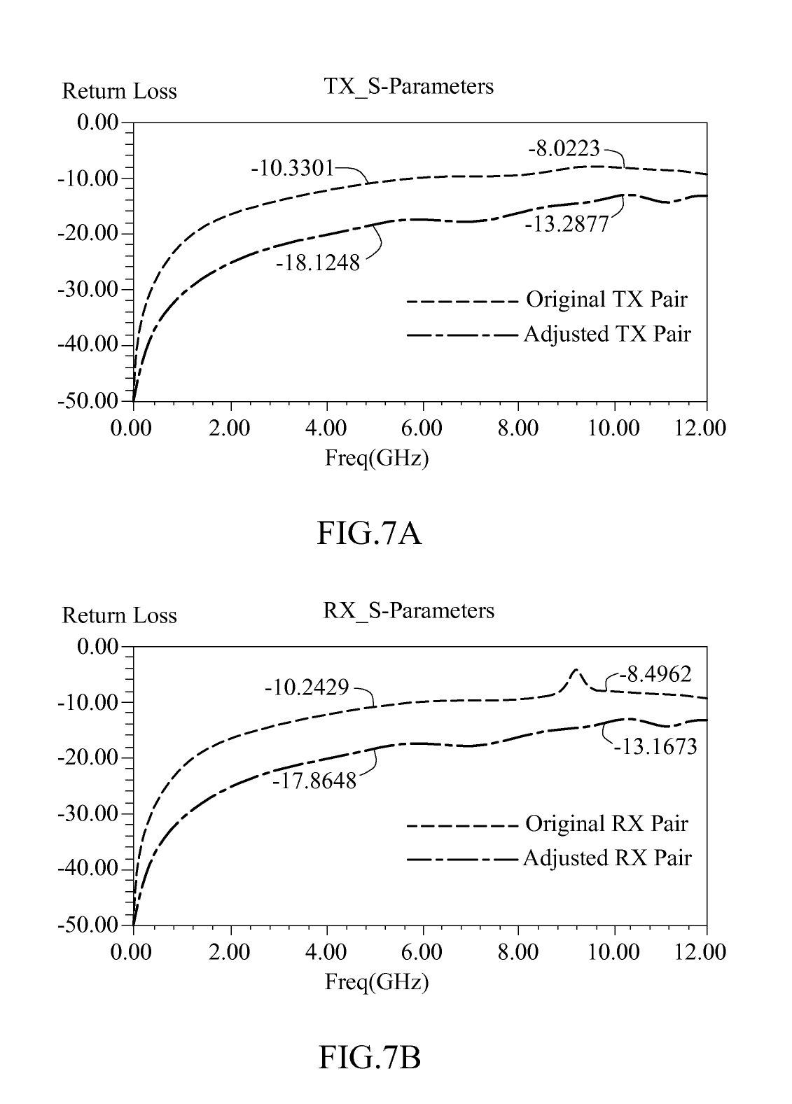

After adjusting the width and/or spacing of the differential pair of the second conductors 123 by taking medium (e.g., air, the insulation holder 124 or the substrate 121) surrounding the second conductors 123 into account, the differential pair of the second conductors 123 may have improved, return loss and voltage standing wave ratio (VSWR). FIG. 7A shows return loss for transmitter differential pair (TX) before and after width/spacing adjustment. It is observed, that the adjusted transmitter differential pair has lower return, loss than the original transmitter differential pair, indicating that the adjusted transmitter differential pair possesses less reflection due to impedance mismatch. Similarly, FIG. 7B shows return loss for receiver differential pair (RX) before and after width./spacing adjustment. It is observed that the adjusted receiver differential pair not only has lower return loss than the original transmitter differential pair, but also has a smoother return loss curve than the original receiver differential pair, indicating that the differential impedances at different locations of the second conductor 123 have been well maintained within the specified range. Accordingly, the differential pair may have a wider bandwidth.

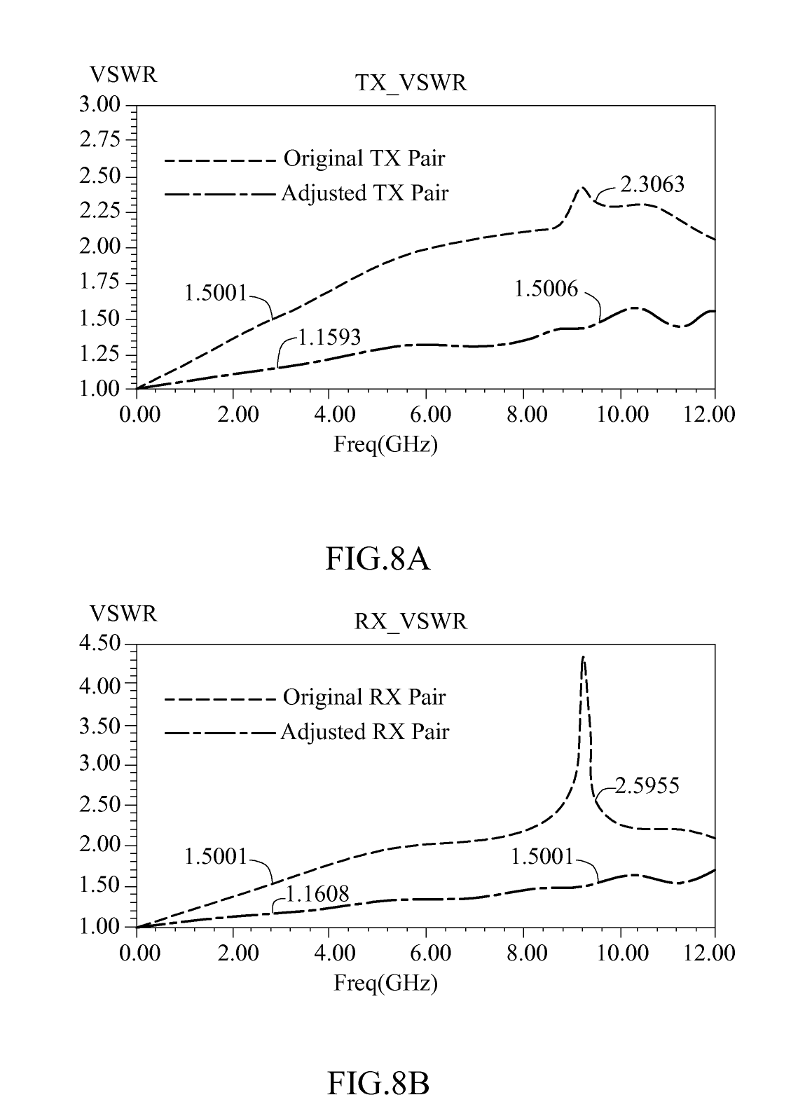

FIG. 8A shows voltage standing wave ratio (VSWR) for transmitter differential pair (TX) before and after width/spacing adjustment. It is observed that the adjusted transmitter differential pair has lower VSWR than the original transmitter differential pair, indicating that the adjusted transmitter differential pair possesses less reflection due to impedance mismatch. It is further observed that the adjusted transmitter differential pair has a smoother VSWR curve than the original transmitter differential pair, indicating that the differential impedances at different locations of the second conductor 1.23 have been well maintained within the specified range. Similarly, FIG. 8B shows VSWR for receiver differential pair (RX) before and after width/spacing adjustment. It is observed that the adjusted receiver differential pair has lower VSWR and a smoother VSWR curve than the original receiver differential pair.

Although specific embodiments have been illustrated and described, it will be appreciated by those skilled in the art that various modifications may be made without departing from the scope of the present invention, which is intended to be limited solely by the appended claims.

What is claimed is:

1. A memory device, comprising:
a control board including a substrate, a plurality of first conductors disposed on a front portion of the substrate, a plurality of second conductors disposed above the substrate and back from the first conductors, and an insulation holder having a plurality of through-holes through which the second conductors pass; and
a conductive housing enclosing the control board;
wherein a circuit ground in the control board is electrically coupled to the conductive housing to make a common ground contact.

2. The memory device of claim 1 conforms to USB 3.0 specification.

3. The memory device of claim 1, further comprising a support frame having a base plate for supporting the control board.

4. The memory device of claim 3, wherein the support frame further comprises:
a front sidewall substantially vertically extending from a front side of the base plate; and
a rear sidewall substantially vertically extending from a rear side of the base plate;
wherein the base plate, the front sidewall and the rear sidewall define a space, into which the control board is fitted.

5. The memory device of claim 4, wherein the support frame further comprises:
a top plate extending from a top side of the rear sidewall and being substantially parallel to the base plate;
wherein a front side of the top plate resists the insulation holder.

6. The memory device of claim 5, wherein the base plate, the top plate or the conductive housing has at least one opening to facilitate heat dissipation.

7. The memory device of claim 1, further comprising at least two extended legs extending from a front side of the insulation holder.

8. The memory device of claim 1, wherein the second conductor has a front portion that is suspended from a top surface of the substrate, a central portion passing through the through-hole of the insulation holder, and a rear portion that rests on the top surface of the substrate.

9. The memory device of claim 1, wherein the second conductor assigned to ground further comprises at least one extended conductor that extends upward and physically contacts the conductive housing to make the common ground contact.

10. The memory device of claim 1, further comprising an extended conductor disposed on a top surface of the substrate, wherein the extended conductor physically contacts the conductive housing and electrically couples to the circuit ground to make the common ground contact.

11. The memory device of claim 1, wherein the control board comprises:
a printed circuit board;
a memory controller and a storage mounted on the printed circuit board by using a chip-on-board (COB) technique; and
a molding layer covering the printed circuit board, the mounted memory controller and the mounted storage.

12. The memory device of claim 11, wherein the control board further comprises at least one power-related element mounted on a surface of the substrate.

13. A memory device, comprising:
a control board including a substrate, a plurality of first conductors disposed on a front portion of the substrate, a plurality of second conductors disposed above the substrate and back from the first conductors, and an insulation holder having a plurality of through-holes through which the second conductors pass; and
a conductive housing enclosing the control board;
wherein the plurality of second conductors include at least one differential pair; and differential impedances at different locations of the second conductor are controllably maintained within, a specified range by adjusting width of the second conductor and/or spacing between the adjacent second conductors of the differential pair.

14. The memory device of claim 13 conforms to USB 3.0 specification.

15. The memory device of claim 13, further comprising a support frame having a base plate for supporting the control board.

16. The memory device of claim 13, wherein the wider the second conductor is, the smaller the differential impedance is.

17. The memory device of claim 13, wherein the smaller the spacing between the adjacent second conductors of the differential pair is, the smaller the differential impedance is.

18. The memory device of claim 13, wherein the second conductor has a front portion that is suspended from a top surface of the substrate, a central portion passing through the through-hole of the insulation holder, and a rear portion that partially rests on the top surface of the substrate.

19. The memory device of claim 18, wherein the width of at least one portion of the front portion of the second conductor is a larger than the width of the central portion of the second conductor.

20. The memory device of claim 19, wherein the spacing between the front portions of the adjacent second conductors of the differential pair is smaller than the spacing of the central portions of the adjacent second conductors of the differential pair.

21. The memory device of claim 18, wherein the width of the rear portion of the second conductor is larger than the width of the central portion of the second conductor.

22. The memory device of claim 21, wherein the spacing between the rear portions of the adjacent second conductors of the differential pair is smaller than the spacing between the central portions of the adjacent second conductors of the differential pair.
